(19) United States
(12) Patent Application Publication
(10) Pub. No.: US 2011/0025226 A1
(43) Pub. Date: Feb. 3, 2011

(54) CONTROL DEVICE FOR CONTROLLING A DISCHARGE LAMP

(75) Inventors: Marcel Beij, Eindhoven (NL); Gerardus Maria Omer De Milliano, Terneuzen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/866,307

(22) PCT Filed: Feb. 5, 2009
(86) PCT No.: PCT/IB09/50475

§ 371 Date: Aug. 5, 2010

(30) Foreign Application Priority Data
Feb. 14, 2008 (EP) 08151435.8

(51) Int. Cl. H05B 41/04

(52) U.S. Cl. 315/291

(57) ABSTRACT

An electronic starter (100) comprises a housing (130) with a bottom face (133) and main input connector terminals (131, 132) projecting externally from the bottom face (133); an electronic switching circuit (150) arranged in the housing (130), the electronic switching circuit (150) comprising: a controllable switch (170), and a control device (180) having a control output terminal (181) coupled to a control input of the switch (170). The control device (180) further has programming input terminals (182). The housing (130) further is provided with a communication connector (140) having a plurality of communication terminals (141) connected to the programming input terminals (182) of the control device (180).

### FIELD OF THE INVENTION

The present invention relates in general to the switching of discharge lamps.

### BACKGROUND OF THE INVENTION

It is generally known that gas discharge lamps, for example the well-known TL-lamps, are driven by an electro magnetic ballast (EM ballast). FIG. 1 is a schematic block diagram, illustrating such conventional EM ballast 1 for a lamp 2. The ballast 1 of this example comprises an inductor L and a capacitor C in series with the lamp 2 to be driven, and a mechanical switch S in parallel to the lamp, typically of a bimetal design. The ballast 1 further has input terminals 3 for connection to mains, typically 230 V 50 Hz voltage in Europe. Lamp connector terminals are indicated at 4. In the case of such conventional ballast, the lamp can only be switched ON and OFF by switching the mains.

In a more sophisticated design, the mechanical switch is replaced by a controllable semiconductor switch, operated by an intelligent control device such as for instance a controller. FIG. 2 is a schematic block diagram, illustrating such ballast 10. Compared to the example of FIG. 1, the mechanical switch S has been replaced by an electronic switching circuit 20. This electronic switching circuit 20 comprises a full-wave rectifier 21 (shown as a four-diode bridge) having input terminals 22, 23 connected in parallel to the lamp 2, and having a positive output terminal 24 an a negative output terminal 25. The electronic switching circuit 20 further comprises an electronic switch 26, shown as a MOSFET, connected between the positive and negative terminals 24, 25.

The electronic switching circuit 20 further comprises a control device 28, having a control output connected to the control terminal of the switch 26. The control device 28 may derive its power from the terminals 24, 25, or may derive its power from an external circuit (not shown). The control device 28 may be responsive to external command signals, transmitted over an external circuit (not shown), via a wired or wireless link, e.g. RF.

In normal operation, the switch 26 is non-conductive. Assume that the lamp is OFF. If the control device 28 wishes to switch ON the lamp 2, it generates a control signal for the switch 26 such as to render the switch 26 conductive. As a consequence, a current will start flowing through the inductor L, charging the capacitor C. After some time, the control device 28 renders the switch 26 non-conductive again. Current flowing in the inductor L will continue to flow, increasing the voltage over the capacitor C, which voltage is present over the lamp terminals. If the voltage exceeds the lamp ignition voltage, the lamp will ignite.

For allowing the control device 28 to implement a correct timing of the switching, the control device 28 inter alia receives a signal indicating momentary current magnitude from a current sensor. In the example of FIG. 2, such current sensor is implemented as a diode 27 coupled in series with the switch 26. The measuring signal, i.e. the voltage developed over the diode, is communicated to the control device 28 via a signal line that is not shown for sake of simplicity.

In order to easily exchange starter switches, the standard mechanical switch S is implemented in a cylindrical housing 30 having two projecting terminals 31, 32 with T-shaped cross-section in one end face 33, as schematically illustrated in FIG. 3, while a lamp armature is provided with a starter socket 35 comprising two socket openings 36, 37 for receiving the starter terminals 31, 32. In order to be able to replace an ordinary mechanical starter, an electronic switching circuit may also be accommodated in such housing 30, with the input terminals 22, 23 connected to the starter terminals 31, 32. For sake of convenience, this will be indicated as an electronic starter.

### SUMMARY OF THE INVENTION

An electronic switching circuit is typically designed to match a certain lamp type. This means that the behavior of the control device 28 is adapted to parameters of, among others, the lamp and the combination of inductor L and capacitor C. In practice, the control device 28 comprises a microcontroller with a memory, and the control behavior is defined by control parameters stored in such memory. Such control parameters may be independent of a certain lamp, or may be adapted to match a certain lamp. Now, it is possible that such control parameters are stored in the memory upon manufacture of the electronic switching circuit. However, this effectively means that it is necessary to manufacture many different types of electronic starters, with increased costs of storage, transport, etc. Further, it is costly to produce a new electronic starter type in case a new lamp type is developed. Further, if wrong parameters are stored in the memory, it is necessary to disassemble the electronic starter if it is required to correct the parameters, which is relatively costly to such extent that the electronic starters can be considered waste.

Further, the memory of the control device may contain information such as an address, a name, software version, production date, etc, and it is desirable to be able to change such information later. Especially, it is desirable to be able to change the software of the control device.

An object of the present invention is to provide an electronic starter wherein the above-mentioned problems are overcome.

In one aspect, the present invention provides additional connector terminals on the housing of the electronic starter, which connector terminals are suitably coupled to suitable terminals of the control device (microcontroller) for enabling communication to the control device, particularly reprogramming of the control device and/or amending parameters in the memory of the control device.

Although these additional connector terminals may in principle be located anywhere on the starter housing, it is preferred that these terminals are located in the same housing face as the input terminals. In that case, these additional terminals are automatically shielded when the starter is mounted, while further the T-shaped input terminals can be used to assist for coupling to a programming device.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a schematic block diagram illustrating a conventional EM ballast with a mechanical switch;

FIG. 2 is a schematic block diagram illustrating an EM ballast with a controllable semiconductor switch;

FIG. 3 is a schematic perspective view of a common mechanical starter housing and corresponding socket;

FIG. 4 is a schematic perspective view of an embodiment of a starter housing according to the present invention;

FIG. 5 is a schematic block diagram illustrating an electronic circuit in the starter housing of FIG. 4;

FIG. 6 is a schematic perspective view of a programming tool.

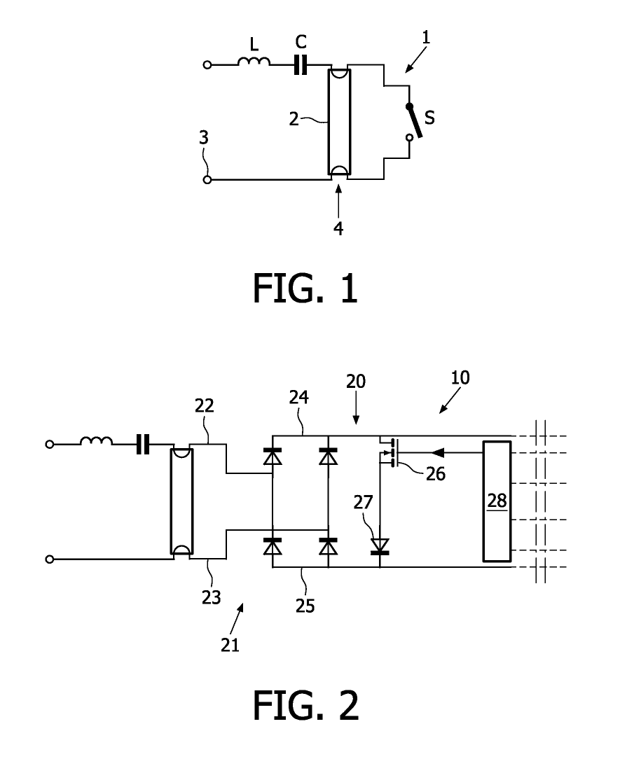

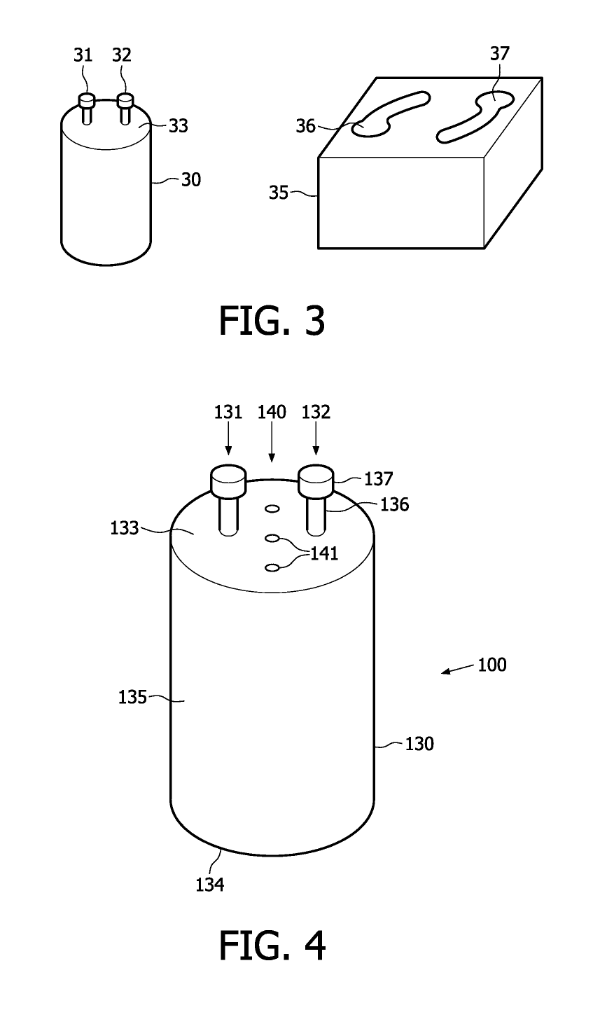

### DETAILED DESCRIPTION OF THE INVENTION

FIG. 4 is a schematic perspective view of a possible embodiment of an electronic starter 100 according to the present invention. This starter 100 comprises a cylindrical housing 130, with a cylindrical side wall 135, a first end face 133 (also indicated as bottom face), and a second end face 134 (also indicated as top face) opposite the bottom face. The starter 100 further comprises two main input connector terminals 131, 132 having a generally T-shaped contour in longitudinal section, projecting externally from the bottom face 133. More particularly, each main input connector terminal 131, 132 comprises a pin 136 of substantially circular cross-section extending substantially perpendicularly from the bottom face 133, and a head 137 of substantially circular cross-section and having a diameter larger than the diameter of the pin 136 arranged at the free end of the pin 136 opposite the bottom face 133.

The starter 100 further comprises a communication connector 140 arranged in the bottom face 133, having a plurality of communication terminals 141 that are distinct from the main input connector terminals 131, 132, i.e. electrically insulated from these main input connector terminals. In the illustrated embodiment, the communication connector 140 comprises three such communication terminals 141, but this number is shown for illustrative purposes rather than restrictive purposes. The communication terminals 141 may be arranged in any suitable array; in the preferred embodiment shown, the communication terminals 141 are arranged in a linear array perpendicular to the line connecting the main input connector terminals 131, 132.

The implementation of the communication terminals 141 is not critical, and can be designed suitably by any person skilled in the art in accordance with his liking. However, in order not to interfere with the normal connectivity of the starter 100 in any type of common socket 35, the communication terminals 141 preferably do not, or only to a negligible extent, project outwards from the bottom face 133. Advantageously, the communication terminals 141 are implemented as a ball-grid terminal, a female bush terminal, or a flat contact flush with or recessed in the bottom face 133. Although the communication terminals 141 may mutually be identical, it is also possible that they are mutually implemented in a different way.

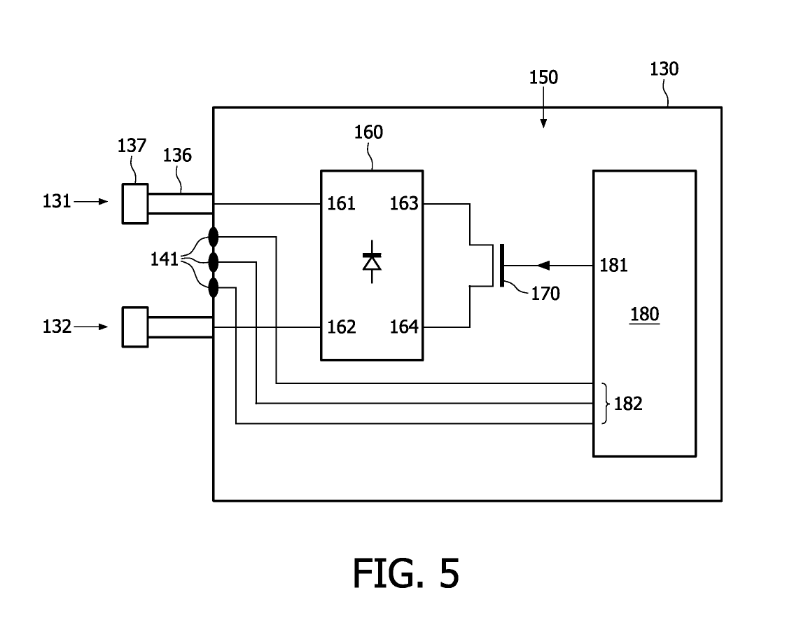

FIG. 5 is a block diagram of the electronic starter 100, illustrating that the starter 100 comprises an electronic switching circuit 150 arranged in the housing 130. This electronic switching circuit 150 comprises a rectifier 160 having its input terminals 161, 162 connected to the main input connector terminals 131, 132, and a controllable switch 170 connected between output terminals 163, 164 of the rectifier 160. The electronic switching circuit 150 further comprises a control device 180, for instance a microcontroller or microprocessor, having a control output terminal 181 coupled to a control input of the switch 170, shown as a MOSFET. The control device 180 may have power input terminals coupled to the output terminals 163, 164 of the rectifier 160 for receiving power, but this is not shown for sake of convenience. The control device 180 further has programming input terminals 182 connected to the communication terminals 141. For instance, two of these programming input terminals 182 may be used for supplying low voltage power (e.g. 2 V) to the control device 180, while a third one of these programming input terminals 182 may be used for supplying data signals to the control device 180. It is possible that a fourth terminal of the control device is connected to a fourth communication terminal for outputting data signals; however, if it is desirable that data can be read from the control device 180, it is also possible that one 2-way data terminal is used allowing both read and write.

In normal operation, the electronic starter 100 is mounted in a starter socket 35; the communication terminals 141 then are not accessible and are shielded by the socket. When it is desired to change the programming of the control device 180, the electronic starter 100 is taken from starter socket 35 so that the communication terminals 141 become accessible. Programming may be done by, for instance, a PC with a suitable connector.

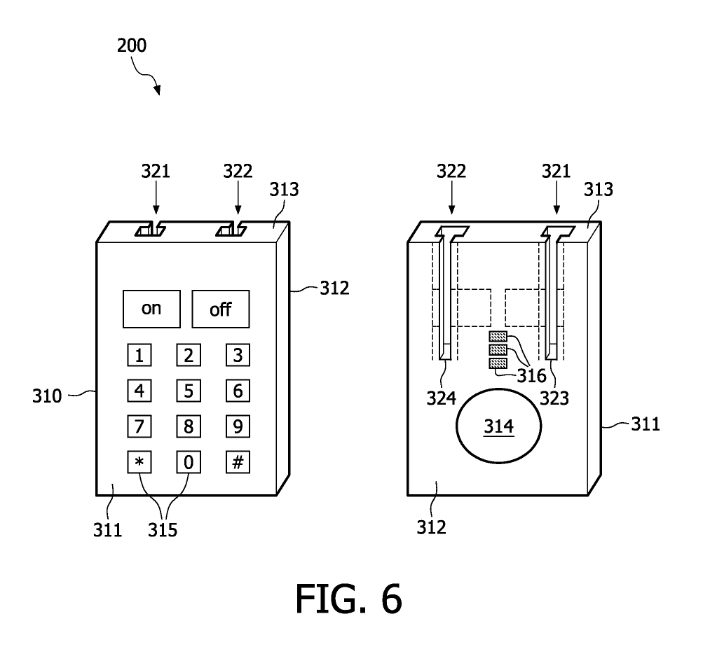

The present invention also provides a specially adapted programming tool 200. FIG. 6 is a schematic perspective view of this programming tool 200, showing the front side (lefthand side of the drawing) and back side (righthand side of the drawing). The tool 200 comprises a box-shaped housing 310 with a front surface 311, a rear surface 312, and a top surface 313. A power source for the tool 200 may be a battery 314 located in the housing. The front surface 311 has control buttons 315. The rear surface 312 has programming contacts 316 adapted for contacting the communication terminals 141. An electronic circuit (not shown), located within the housing 310, is connected to these programming contacts 316.

For easy cooperation with the electronic starter 100, the housing 310 has two mutually parallel guiding channels 321 and 322 formed in the rear surface 312, each guiding channel having a T-shaped cross-section matching the cross-section of the main starter input connector terminals 131, 132, and each extending from the top surface 313 to a position close to the programming contacts 316. The main input connector terminals 131, 132 are inserted in these guiding channels 321, 322, and the starter 100 is moved downwards until the terminals 131, 132 abut the respective ends 323, 324 of the guiding channels 321, 322. When the starter 100 is in this position defined by the ends 323, 324 of the guiding channels 321, 322, which will be indicated as a programming position, the communication terminals 141 are aligned with and in contact with the programming contacts 316. It is not necessary for the user to hold on to the starter 100, because the shape of the guiding channels 321, 322 assures that the main starter input connector terminals 132, 132 are held firmly. After the starter 100 has been (re-)programmed, the starter 100 is disconnected simply by shifting the starter towards the top surface 313.

It is also possible to copy the settings of one starter 100 (master) into one or a plurality of other starters (slaves). In a first step, the master starter is mounted to the tool 200, and its settings are read and stored in a memory of the tool 200. In a second step, a slave starter is mounted to the tool 200, and the settings are communicated to its control device. This second step can be repeated for multiple slaves.

Summarizing, the present invention provides an electronic starter 100 comprising a housing 130 with a bottom face 133 and main input connector terminals 131, 132 projecting externally from the bottom face 133. The starter further comprises an electronic switching circuit 150 arranged in the housing 130, the electronic switching circuit 150 comprising:
a controllable switch 170, and
a control device 180 having a control output terminal 181 coupled to a control input of the switch 170.

The control device 180 further has programming input terminals 182.

The housing 130 further is provided with a communication connector 140 having a plurality of communication terminals 141 connected to the programming input terminals 182 of the control device 180.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, the electronic circuit in the starter 100 may differ from the circuit shown and discussed. Especially, embodiments are possible in which the rectifier is omitted.

Further, it should be clear that the exact implementation of the electronic circuit of the programming tool (200) is not important.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Electronic starter (100) comprising a housing (130) with a bottom face (133) and main input connector terminals (131, 132) projecting externally from the bottom face (133);
an electronic switching circuit (150) arranged in the housing (130), the electronic switching circuit (150) comprising:
a controllable switch (170), and
a control device (180) having a control output terminal (181) coupled to a control input of the switch (170);
wherein the control device (180) further has programming input terminals (182);
and wherein the housing (130) further is provided with a communication connector (140) having a plurality of communication terminals (141) connected to the programming input terminals (182) of the control device (180).

2. Electronic starter according to claim 1, wherein the communication terminals (141) are arranged in or on the bottom face (133) of the housing (130).

3. Electronic starter according to claim 2, wherein the communication terminals (141) are arranged in a linear array perpendicular to the line connecting the main input connector terminals (131, 132).

4. Electronic starter according to claim 1, wherein the communication terminals (141) are implemented as an implementation selected from the group consisting of ball-grid terminal, female bush terminal, flat contact flush with the bottom face, flat contact recessed in the bottom face.

5. Electronic starter according to claim 1, wherein the main input connector terminals (131, 132) have a generally T-shaped contour in longitudinal section.

6. Electronic starter according to claim 1, wherein two of the communication terminals (141) are connected to power input terminals of the control device (180).

7. Electronic starter according to claim 1, wherein one of the communication terminals (141) is connected to a data input terminal of the control device (180).

8. Electronic starter according to claim 7, wherein another one of the communication terminals (141) is connected to a data output terminal of the control device (180).

9. Electronic starter according to claim 7, wherein said one of the communication terminals (141) is connected to a data input/output terminal of the control device (180).

10. Programming tool (200) for cooperation with an electronic starter according to claim 1, comprising a box-shaped housing (310) having an operating surface (312) with two receptacles (321, 322) for receiving the main input connector terminals (131, 132) of the starter (100), the receptacles defining a programming position for the starter (100);
wherein the operating surface (312) further comprises programming contacts (316) located such that, when the starter (100) is in said programming position, its communication terminals (141) are aligned with and in contact with said programming contacts (316);
wherein the programming tool (200) further comprises an electronic circuit located within the housing (310) and connected to said programming contacts (316).

11. Programming tool (200) for cooperation with an electronic starter according to claim 1, comprising a box-shaped housing (310) having an operating surface (312) with two receptacles (321, 322) for receiving the main input connector terminals (131, 132) of the starter (100), the receptacles defining a programming position for the starter (100);
wherein the operating surface (312) further comprises programming contacts (316) located such that, when the starter (100) is in said programming position, its communication terminals (141) are aligned with and in contact with said programming contacts (316);
wherein the programming tool (200) further comprises an electronic circuit located within the housing (310) and connected to said programming contacts (316) for cooperation with an electronic starter according to claim 5, wherein the housing (310) has two mutually parallel guiding channels (321, 322) formed in the operating surface (312), each guiding channel having a T-shaped cross-section matching the cross-section of the main starter input connector terminals (131, 132), and each extending from an open end at an edge of the operating surface (312) to a stop (323, 324) for the main starter input connector terminals (131, 132).

12. System comprising at least one electronic starter 100) comprising a housing (130) with a bottom face (133) and main input connector terminals (131, 132) projecting externally from the bottom face (133);
an electronic switching circuit (150) arranged in the housing (130), the electronic switching circuit (150) comprising:
a controllable switch (170), and
a control device (180) having a control output terminal (181) coupled to a control input of the switch (170);
wherein the control device (180) further has programming input terminals (182);
and wherein the housing (130) further is provided with a communication connector (140) having a plurality of communication terminals (141) connected to the programming input terminals (182) of the control device (180) and a programming tool according to claim 10, wherein the electronic circuit of the programming tool and the control device of the starter are capable of communicating with each other such as to store operating parameters into a memory of the control device.

13. System according to claim 12, wherein the electronic circuit of the programming tool and the control device of the starter are capable of communicating with each other such as to read operating parameters from the memory of the control device.

14. System according to claim 12, wherein the electronic circuit of the programming tool and the control device of the starter are capable of communicating with each other such as to copy operating parameters from the memory of a master starter to the memory of at least one slave starter.
